(19) United States
(12) Patent Application Publication
(10) Pub. No.: US 2021/0340999 A1
(43) Pub. Date: Nov. 4, 2021

(54) ACCUMULATOR AND METHOD OF OPERATING ACCUMULATOR

(71) Applicant: Caterpillar Inc., Peoria, IL (US)

(72) Inventors: Ryan Robert Stoffel, Oswego, IL (US); John Michael Connelly, Tinley Park, IL (US); Beau Daniel Kuipers, Morris, IL (US); Satchit Pradip Panse, Naperville, IL (US)

(73) Assignee: Caterpillar Inc., Peoria, IL (US)

(21) Appl. No.: 16/864,210

(22) Filed: May 1, 2020

(51) Int. Cl. F15B 1/24; E02F 9/22

(52) U.S. Cl. CPC F15B 1/24; E02F 9/2217

(57) ABSTRACT

An accumulator includes an accumulator housing defining a first end, a second end opposite to the first end, and a hollow chamber. The accumulator also includes a piston slidably disposed within the hollow chamber and adapted to displace between the first and second ends. The piston divides the hollow chamber into a gaseous chamber proximate to the first end of the accumulator housing and a hydraulic chamber proximate to the second end of the accumulator housing. Further, the piston defines a first side surface in communication with the gaseous chamber and a second side surface spaced apart from the first side surface. The second side surface is in communication with the hydraulic chamber. A cavity of the piston is in communication with the second side surface and extends from the second side surface towards the first side surface. The cavity is in fluid communication with the hydraulic chamber.

### TECHNICAL FIELD

The present disclosure relates to an accumulator and a method of operating the accumulator.

### BACKGROUND

A machine typically includes one or more accumulators, such as a piston type accumulator, associated with the machine. For example, the accumulator may be associated with lift/tilt cylinders of a machine linkage assembly or a machine braking system. As per application requirements, the accumulator may be used to smooth out pulsations/vibrations or to build-up pressure in the associated hydraulic system. The accumulator typically includes a housing and a piston that is slidably disposed within the housing. The piston divides a hollow space of the housing into a liquid chamber and a gaseous chamber. The liquid chamber is adapted to receive liquid flow from another hydraulic device, whereas the gaseous chamber is pre-charged with gases to a desired pressure.

Further, the piston includes a cavity such that the cavity faces the gaseous chamber. The cavity creates a trapped volume for the gas pre-charge in the gaseous chamber and also increases an overall volume of the gaseous chamber. When the accumulator is in operation and the piston moves towards the gaseous chamber due to fluid pressure from the incoming liquid flow, a pressure differential is created between the liquid and gaseous chambers. This pressure differential is created due to the increased volume of the gaseous chamber owing to the presence of the cavity. Due to the additional volume presented by cavity, the gas pre-charge gets trapped within the cavity. The trapped gases may not compress to a high level due to which a pressure in the gaseous chamber is lesser than a pressure in the liquid chamber. Such a pressure differential is highest when the piston is completely displaced towards the gaseous chamber causing liquid from the liquid chamber to flow past piston sealing rings towards the gaseous chamber. This leakage causes mixing of the liquid with the gas pre-charge which may cause loss of the gas pre-charge. The loss of gas pre-charge may in turn contribute to poor accumulator performance and reduce an efficiency of the hydraulic system, which is not desirable.

U.S. Pat. No. 7,108,016 describes a lightweight, low permeation, piston-in-sleeve high-pressure accumulator. The accumulator includes a cylindrical composite pressure vessel with two integral rounded ends. A piston slidably disposed in a thin nonpermeable internal sleeve in the accumulator separates two chambers, one adapted for containing a working fluid and the other adapted for containing gas under pressure. Working fluid is provided in a volume between the nonpermeable internal sleeve and the composite pressure vessel wall. Further means are provided for withstanding harmful effects of radial flexing of the composite vessel wall under high pressures, and from stresses present in use in mobile applications such as with a hydraulic power system for a hydraulic hybrid motor vehicle. A method for pre-charging the device is also presented.

### SUMMARY OF THE DISCLOSURE

In an aspect of the present disclosure, an accumulator is provided. The accumulator includes an accumulator housing defining a first end, a second end opposite to the first end, and a hollow chamber. The accumulator also includes a piston slidably disposed within the hollow chamber and adapted to displace between the first and second ends. The piston divides the hollow chamber into a gaseous chamber proximate to the first end of the accumulator housing and a hydraulic chamber proximate to the second end of the accumulator housing. Further, the piston defines a first side surface in communication with the gaseous chamber. The piston also defines a second side surface spaced apart from the first side surface such that a length of the piston is defined between the first and second side surfaces. The second side surface is in communication with the hydraulic chamber. Further, a cavity of the piston is in communication with the second side surface such that the cavity extends from the second side surface towards the first side surface along the length of the piston. The cavity is in fluid communication with the hydraulic chamber.

In another aspect of the present disclosure, a method of operating an accumulator is provided. The method includes communicating, fluidly, the accumulator with at least one hydraulic device. The accumulator includes an accumulator housing defining a first end, a second end opposite to the first end, and a hollow chamber. The accumulator also includes a piston that divides the hollow chamber into a gaseous chamber and a hydraulic chamber. The piston defines a first side surface in communication with the gaseous chamber, a second side surface in communication with the hydraulic chamber, and a cavity extending from the second side surface towards the first side surface along a length of the piston such that the cavity is in fluid communication with the hydraulic chamber. The method also includes receiving, from the at least one hydraulic device, a hydraulic fluid within the hydraulic chamber and the cavity. The method further includes displacing the piston towards the first end by a maximum displacement based on receipt of the hydraulic fluid within the hydraulic chamber and the cavity. Further, a first pressure within the gaseous chamber is greater than a second pressure within the hydraulic chamber and the cavity when the piston is displaced towards the first end by the maximum displacement.

Other features and aspects of this disclosure will be apparent from the following description and the accompanying drawings.

### BRIEF DESCRIPTION OF THE DRAWINGS

FIG. 1 is a perspective view of a machine, according to one embodiment of the present disclosure;

FIG. 2 is a perspective view of a linkage assembly associated with the machine of FIG. 1;

FIG. 3 illustrates a schematic view of an accumulator associated with the machine of FIG. 1;

FIG. 4 illustrates a cross-sectional view of a piston associated with the accumulator of FIG. 3; and

FIG. 5 is a flowchart for a method of operating the accumulator.

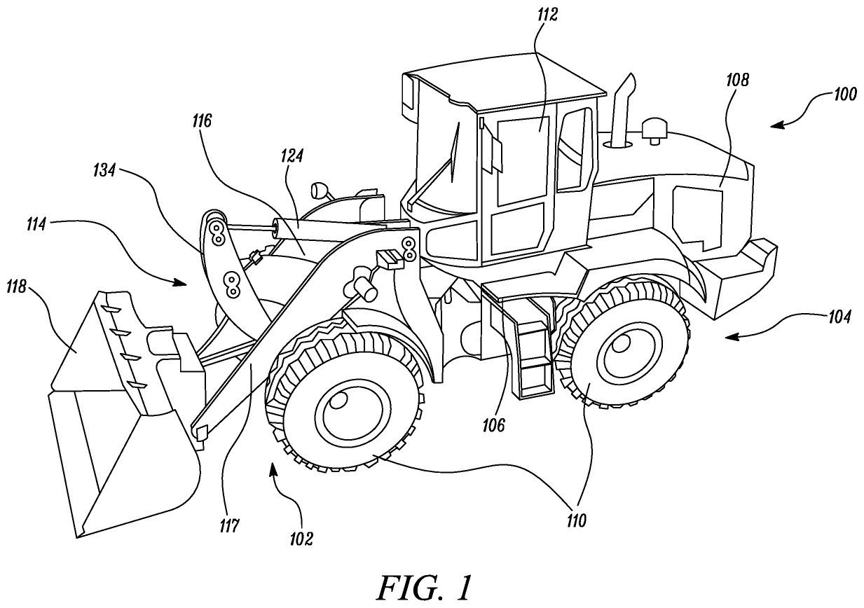

### DETAILED DESCRIPTION

Wherever possible, the same reference numbers will be used throughout the drawings to refer to the same or like parts. Referring to FIG. 1, a perspective view of an exemplary machine 100 is illustrated. The machine 100 is embodied as a medium wheel loader herein. Alternatively, the machine 100 may include a large wheel loader, a skid steer loader, an excavator, a milling machine, and the like. The machine 100 defines a front end 102 and a rear end 104. The machine 100 includes a frame 106. The frame 106 supports various components of the machine 100 thereon. The machine 100 includes an enclosure 108 mounted on the frame 106 proximate to the rear end 104 of the machine 100. The enclosure 108 encloses a power source (not shown) therein. The power source may be any power source, such as an internal combustion engine, batteries, motor, and so on. The power source provides power to the machine 100 for operational and mobility requirements.

The machine 100 also includes a set of ground engaging members 110. The ground engaging members 110 are operably coupled to the frame 106. In the illustrated embodiment, the ground engaging members 110 include wheels. In other embodiments, the ground engaging members 110 may include tracks, or a combination of tracks and wheels, based on a type of the machine 100. The ground engaging members 110 support and provide mobility to the machine 100 on ground surfaces.

The machine 100 includes a machine operator station 112 mounted on the frame 106. The machine operator station 112 includes various input devices to control various functions associated with the machine 100. Further, a braking system (not shown) is associated with the machine 100 for reducing a speed of the machine 100 or to stop the machine 100. The braking system may be embodied as a hydraulic braking system that includes components (not shown) such as an accumulator, a pump assembly that is driven to maintain hydraulic pressure in the accumulator, a master cylinder assembly, a brake caliper assembly, a reservoir, and the like.

Further, a linkage assembly 114 is attached to the frame 106 of the machine 100. The linkage assembly 114 includes a pair of lift arms 116, 117. An implement 118, such as a bucket, is pivotally coupled to the lift arms 116, 117. During operation of the machine 100, the lift arms 116, 117 and the implement 118 may be moved to different positions to perform operations such as excavating, loading, and dumping, based on application requirements. It may be noted that the linkage assembly 114 and the implement 118 may vary based on the type of the machine 100 or a type of operation or task required to be carried out by the machine 100.

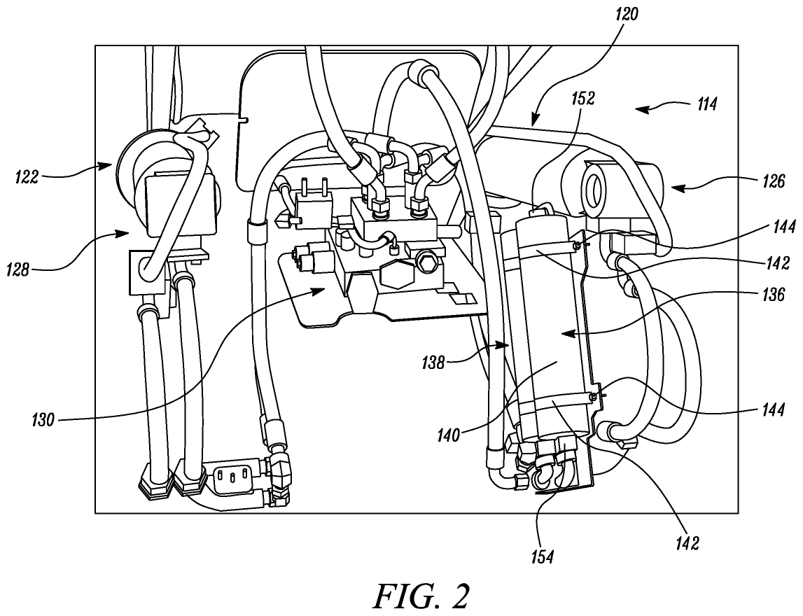

As shown in FIG. 2, the linkage assembly 114 includes a pair of first hydraulic actuators 120, 122 and a second hydraulic actuator 124 (shown in FIG. 1). More particularly, the pair of first hydraulic actuators 120, 122 are mounted between the frame 106 (see FIG. 1) and the respective link arms 116, 117 (see FIG. 1). The first hydraulic actuators 120, 122 include a corresponding head end 126, 128 that is connected to the frame 106 and a rod end (not shown) that is connected to the respective lift arms 116, 117. The first hydraulic actuators 120, 122 effectuate a lifting movement of the link arms 116, 117 which in turn causes lifting of the implement 118 (see FIG. 1).

Further, the second hydraulic actuator 124 is mounted between the frame 106 and a tilt lever 134 (shown in FIG. 1) to effectuate a tilting of the implement 118. The tilt lever 134 is in turn coupled with the implement 118. For a given position of the lift arms 116, 117, the implement 118 is rotated toward a racked position by extending the second hydraulic actuator 124 and rotated in the opposite direction toward a dump position by retracting the second hydraulic actuator 124.

Further, the machine 100 includes one or more accumulators 136, 138. The accumulators 136, 138 are in selective fluid communication with one or more hydraulic devices 120, 122. In the illustrated example, the one or more hydraulic devices 120, 122 are embodied as the first hydraulic actuators 120, 122. The hydraulic device 120, 122 may be hereinafter interchangeably referred to as the first hydraulic actuators 120, 122, without any limitations. Alternatively, the accumulator 136, 138 may be associated with the second hydraulic actuator 124, the braking system, or any other hydraulic system of the machine 100, without any limitations.

Further, the machine 100 includes a valve assembly 130. In some examples, the valve assembly 130 forms a part of the linkage assembly 114. The valve assembly 130, the accumulator 136, 138, the first hydraulic actuator 120, 122, and the second hydraulic actuator 134 may be connected via a number of fluid conduits. The valve assembly 130 may control an operation of the linkage assembly 114. The valve assembly 130 may be activated or deactivated based on control signals received from a machine control unit (not shown) present onboard the machine 100.

In addition to other functionalities, the valve assembly 130 provides fluid communication between the accumulator 136, 138 and the first hydraulic actuator 120, 122. The accumulator 136, 138 may be connected with the first hydraulic actuator 120, 122 via the valve assembly 130. More particularly, when the valve assembly 130 is activated, the valve assembly 130 provides fluid communication between the accumulator 136, 138 and the first hydraulic actuator 120, 122. Further, when the valve assembly 130 is deactivated, the valve assembly 130 restricts fluid communication between the accumulator 136, 138 and the first hydraulic actuator 120, 122. It should be noted that the valve assembly 130 may be activated or deactivated to allow or restrict fluid communication between the accumulator 136, 138 and the first hydraulic actuator 120, 122 based on activation of a ride control feature associated with the machine 100. When the ride control feature is activated, the accumulator 136, 138 absorbs any splashes or shocks during roading of the machine 100 so that the machine 100 is not exposed to sudden shocks or jumps.

Further, the accumulators 136, 138 are similar to each other in terms of design and functionalities. Thus, for explanatory purposes, the accumulator 136 associated with the first hydraulic actuator 120 will now be explained in detail. However, the description provided below is equally applicable to the accumulator 138. Further, the accumulator 136 includes an accumulator housing 140. The accumulator housing 140 is embodied as a hollow cylindrical member. The accumulator housing 140 is removably coupled with the frame 106 using a pair of straps 142 and mechanical fasteners 144.

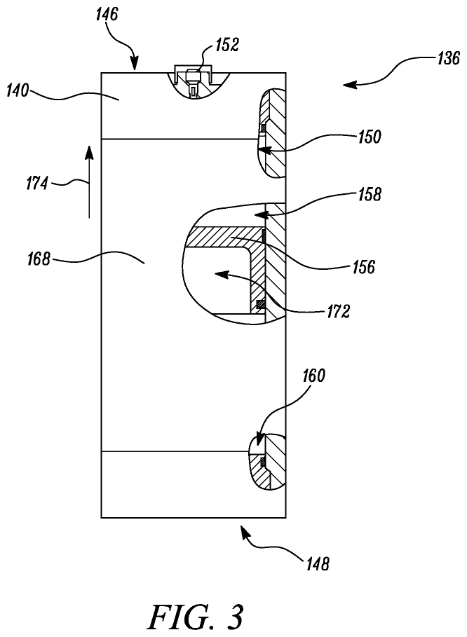

Referring to FIG. 3, the accumulator housing 140 defines a first end 146, a second end 148 opposite to the first end 146, and a hollow chamber 150. The accumulator housing 140 includes a first port 152 provided proximate to the first end 146 and a second port 154 provided proximate to the second end 148. Further, the accumulator 136 includes a piston 156 slidably disposed within the hollow chamber 150. The piston 156 displaces between the first and second ends 146, 148. Further, the piston 156 divides the hollow chamber 150 into a gaseous chamber 158 proximate to the first end 146 of the accumulator housing 140 and a hydraulic chamber 160 proximate to the second end 148 of the accumulator housing 140. Details of the gaseous chamber 158 and the hydraulic chamber 160 will be explained later in this section.

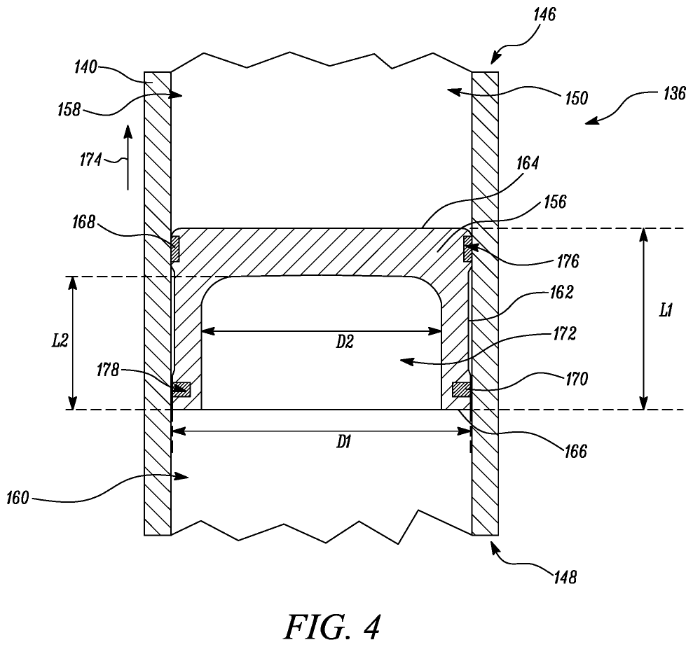

As shown in FIG. 4, the piston 156 includes a cylindrical cup shaped structure. Further, the piston defines a diameter “D1”. The piston 156 defines an outer surface 162. The outer surface 162 is concentric with the accumulator housing 140 when the piston 156 is mounted in the accumulator housing 140. The piston 156 defines a first side surface 164 in communication with the gaseous chamber 158. The piston 156 also defines a second side surface 166 spaced apart from the first side surface 164 such that a length “L1” of the piston 156 is defined between the first and second side surfaces 164, 166. The second side surface 166 is in communication with the hydraulic chamber 160.

Further, the piston 156 includes a wear band 168 disposed within a first groove 176. The first groove 176 is defined proximate to the first side surface 164. The first groove 176 extends circumferentially along the outer surface 162 of the piston 156. Moreover, the piston 156 includes one or more sealing rings 170. In the illustrated example, the piston 156 includes the single sealing ring 170 disposed within a second groove 178. The second groove 178 is defined proximate to the second side surface 166. The second groove 178 extends circumferentially along the outer surface 162 of the piston 156. Alternatively, the piston 156 may include multiple second grooves 178 to accommodate multiple sealing rings 170 therein.

Further, the piston 156 defines a cavity 172 in communication with the second side surface 166 such that the cavity 172 extends from the second side surface 166 towards the first side surface 164 along the length “L1” of the piston 156. The cavity 172 is in fluid communication with the hydraulic chamber 160. The cavity 172 is spaced apart from the second side surface 166. The cavity 172 is centrally disposed within the piston 156. The cavity 172 is circular in shape such that a diameter “D2” of the cavity 172 is concentric with the diameter “D1” of the piston 156. In some examples, the diameter “D2” of the cavity 172 is more than half of the diameter “D1” of the piston 156. Further, the cavity 172 extends along more than half of the length “L1” of the piston 156. More particularly, a length “L2” defined by the cavity 172 is more than half of the length “L1” of the piston 156.

Further, the gaseous chamber 158 is adapted to contain a pre-charged quantity of gas therein. In an example, the gas is nitrogen. The pre-charged quantity of gas is introduced in the gaseous chamber 158 through the first port 152 (see FIGS. 2 and 3). The first port 152 may incorporate a valve therein. Further, the gaseous chamber 158 defines a first volume “V1” that varies based on a displacement of the piston 156. More particularly, the first volume “V1” decreases as the piston 156 displaces towards the first end 146 and the first volume “V1” increases as the piston 156 displaces towards the second end 148. The piston 156 displaces towards the first end 146 along a direction 174.

Further, the pre-charged quantity of gas is compressed based on the displacement of the piston 156 towards the first end 146. A first pressure “P1” within the gaseous chamber 158 increases based on the displacement of the piston 156 towards the first end 146. The increase in the first pressure “P1” is a result of the compression of the pre-charged quantity of gas. Moreover, the first pressure “P1” within the gaseous chamber 158 decreases based on the displacement of the piston 156 towards the second end 148 and expansion of the pre-charged quantity of gas.

Further, the hydraulic chamber 160 and the cavity 172 contain a hydraulic fluid therein. In an example, the hydraulic fluid is oil. When the valve assembly 130 (see FIG. 2) is activated, the hydraulic chamber 160 and the cavity 172 are in fluid communication with the first hydraulic actuator 120 (see FIG. 2). More particularly, the hydraulic chamber 160 and the cavity 172 are in fluid communication with the head end 126 (see FIG. 2) of the first hydraulic actuator 120. Further, the hydraulic chamber 160 and the cavity 172 receive the hydraulic fluid from the first hydraulic actuator 120. The piston 156 displaces towards the first end 146 based on receipt of the hydraulic fluid from the first hydraulic actuator 120. It should be noted that the hydraulic fluid is introduced into the hydraulic chamber 160 and the cavity 172 through the second port 154 (see FIG. 2).

Further, the hydraulic chamber 160 and the cavity 172 of the piston 156 define a second volume “V2” that varies based on the displacement of the piston 156. The second volume “V2” is isolated from the first volume “V1”. More particularly, the second volume “V2” is isolated from the first volume “V1” by the sealing ring 170 associated with the piston 156. The second volume “V2” increases as the piston 156 displaces towards the first end 146 and the second volume “V2” decreases as the piston 156 displaces towards the second end 148.

Further, the second volume “V2” is greater than the first volume “V1” when the piston 156 is displaced towards the first end 146 by a maximum displacement. The term “maximum displacement” as referred to herein may be indicative of a maximum allowable travel of the piston 156 towards the first end 146 along the direction 174. As the gaseous chamber 158 is filled with the pre-charged quantity of gas, the piston 156 may not fully displace towards the first end 146. The displacement of the piston 156 may be dependent on a type, pressure, and amount of the pre-charged quantity of gas. Accordingly, the maximum displacement of the piston 156 may vary based on the type, pressure, and amount of the pre-charged quantity of gas.

When the valve assembly 130 is activated, the hydraulic chamber 160 and the cavity 172 receive the hydraulic fluid from the head end 126 of the first hydraulic actuator 120. The hydraulic fluid entering the accumulator housing 140 pressurizes the hydraulic chamber 160 and the cavity 172 to a second pressure “P2”. As the second pressure “P2” within the hydraulic chamber 160 and the cavity 172 increases, the piston 156 starts displacing towards the first end 146. The displacement of the piston 156 towards the first end 146 causes the second volume “V2” to increase. Moreover, the displacement of the piston 156 towards the first end 146 causes the first volume “V1” to decrease and the first pressure “P1” in the gaseous chamber 158 to increase.

Based on receipt of continual hydraulic fluid within the hydraulic chamber 160 and the cavity 172, the piston 156 is displaced towards the first end 146 by the maximum displacement. When the piston 156 is displaced towards the first end 146 by the maximum displacement, the second volume “V2” is greater than the first volume “V1”. Thus, based on reduction in the first volume “V1”, the pre-charged quantity of gas are compressed to the maximum allowable pressure which in turn increases the first pressure “P1” in the gaseous chamber 158. Further, the first pressure “P1” is greater than the second pressure “P2” within the hydraulic chamber 160 and the cavity 172 when the piston 156 is displaced towards the first end 146 by the maximum displacement.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

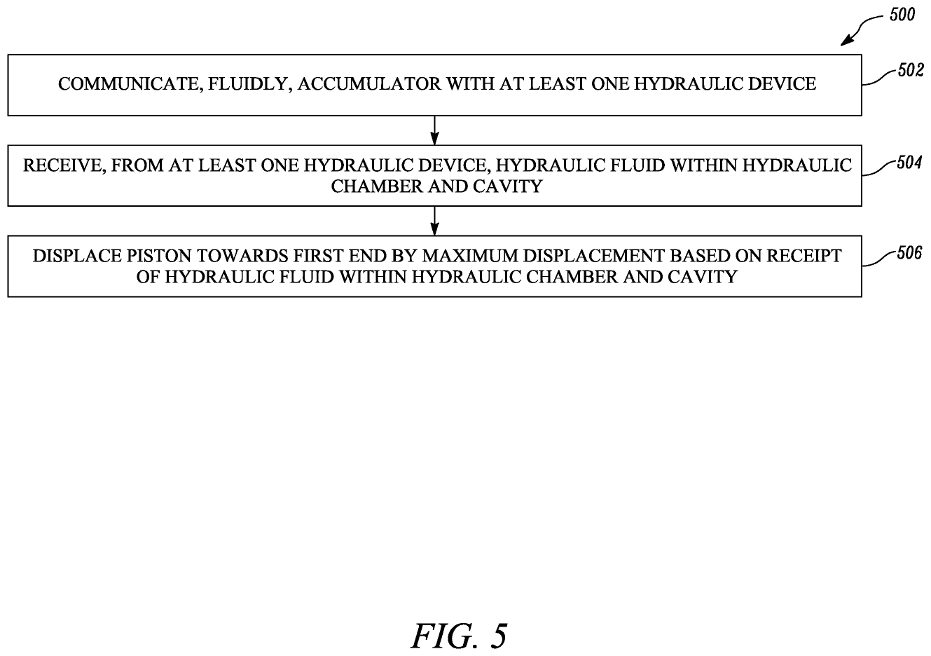

This section will now be explained in relation to the accumulator 136 associated with the first hydraulic actuator 120. However, it should be noted that the details provided in this section is equally applicable to the accumulator 138, without any limitations. FIG. 5 illustrates a flowchart for a method 500 of operating the accumulator 136. At step 502, the accumulator 136 is fluidly communicated with the hydraulic device 120. The accumulator 136 includes the accumulator housing 140 defining the first end 146, the second end 148 opposite to the first end 146, and the hollow chamber 150.

The accumulator 136 also includes the piston 156 that divides the hollow chamber 150 into the gaseous chamber 158 and the hydraulic chamber 160. Further, the piston 156 defines the first side surface 164 in communication with the gaseous chamber 158, the second side surface 166 in communication with the hydraulic chamber 160, and the cavity 172 extending from the second side surface 166 towards the first side surface 164 along the length “L1” of the piston 156 such that the cavity 172 is in fluid communication with the hydraulic chamber 160.

At step 504, the hydraulic fluid is received within the hydraulic chamber 160 and the cavity 172 from the hydraulic device 120. More particularly, the hydraulic fluid is received based on the fluid communication of the hydraulic chamber 160 and the cavity 172 with the hydraulic device 120. At step 506, the piston 156 is displaced towards the first end 146 by the maximum displacement based on receipt of the hydraulic fluid within the hydraulic chamber 160 and the cavity 172. Further, the first pressure “P1” within the gaseous chamber 158 is greater than the second pressure “P2” within the hydraulic chamber 160 and the cavity 172 when the piston 156 is displaced towards the first end 146 by the maximum displacement. The first pressure “P1” within the gaseous chamber 158 increases based on the compression of the pre-charged quantity of gas within the gaseous chamber 158.

Moreover, the first volume “V1” defined by the gaseous chamber 158 decreases based on the displacement of the piston 156 towards the first end 146. Simultaneously, the second volume “V2” defined by the hydraulic chamber 160 and the cavity 172 increases based on the displacement of the piston 156 towards the first end 146. Further, the second volume “V2” is greater than the first volume “V1” when the piston 156 is displaced towards the first end 146 by the maximum displacement.

The accumulator 136 of the present disclosure can be used in a variety of hydraulic applications, including but not limited to, the hydraulic system of the linkage assembly 114 and the braking system associated with the machine 100. The accumulator 136 includes the piston 156 having the cavity 172. The piston 156 is disposed within the accumulator housing 140 such that the cavity 172 is in fluid communication with the hydraulic chamber 160.

When the piston 156 is displaced towards the first end 146 by the maximum displacement, the presence of the cavity 172 in fluid communication with the hydraulic chamber 160 causes the second volume “V2” to be greater than the first volume “V1”. Due to the decreased first volume “V1”, the gaseous chamber 158 attains the first pressure “P1” that is greater than the second pressure “P2” within the hydraulic chamber 160 and the cavity 172. This phenomenon in turn reduces a condition of a high pressure differential between the hydraulic chamber 160 and the gaseous chamber 158. Accordingly, a leakage of the hydraulic fluid from the hydraulic chamber 160 towards the gaseous chamber 158 is prevented. Thus, the accumulator 136 may operate with improved efficiency and eliminate a possibility of loss of pre-charged quantity of gas. Further, due to improved isolation of the gaseous and hydraulic chambers 158, 160, a frequency of servicing/replacement of the accumulator 136 may reduce which may in turn reduce a downtime associated with the machine 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. An accumulator comprising:
an accumulator housing defining a first end, a second end opposite to the first end, and a hollow chamber; and
a piston slidably disposed within the hollow chamber and adapted to displace between the first and second ends, wherein the piston divides the hollow chamber into a gaseous chamber proximate to the first end of the accumulator housing and a hydraulic chamber proximate to the second end of the accumulator housing, and wherein the piston defines:
a first side surface in communication with the gaseous chamber; and
a second side surface spaced apart from the first side surface such that a length of the piston is defined between the first and second side surfaces, wherein the second side surface is in communication with the hydraulic chamber, and wherein a cavity of the piston is in communication with the second side surface such that the cavity extends from the second side surface towards the first side surface along the length of the piston, the cavity being in fluid communication with the hydraulic chamber.

2. The accumulator of claim 1, wherein the hydraulic chamber and the cavity is adapted to contain a hydraulic fluid therein.

3. The accumulator of claim 1, wherein the gaseous chamber is adapted to contain a pre-charged quantity of gas therein.

4. The accumulator of claim 3, wherein the pre-charged quantity of gas is compressed based on a displacement of the piston towards the first end.

5. The accumulator of claim 1, wherein a first pressure within the gaseous chamber increases based on a displacement of the piston towards the first end.

6. The accumulator of claim 5, wherein the first pressure is greater than a second pressure within the hydraulic chamber and the cavity when the piston is displaced towards the first end by a maximum displacement.

7. The accumulator of claim 1, wherein the gaseous chamber defines a first volume that varies based on a displacement of the piston.

8. The accumulator of claim 7, wherein the hydraulic chamber and the cavity of the piston define a second volume that varies based on the displacement of the piston, wherein the second volume is isolated from the first volume.

9. The accumulator of claim 8, wherein the second volume is isolated from the first volume by at least one sealing ring associated with the piston.

10. The accumulator of claim 8, wherein the second volume is greater than the first volume when the piston is displaced towards the first end by a maximum displacement.

11. The accumulator of claim 1, wherein the accumulator is in selective fluid communication with at least one hydraulic device.

12. The accumulator of claim 11, wherein the hydraulic chamber and the cavity are adapted to receive a hydraulic fluid from the at least one hydraulic device.

13. The accumulator of claim 12, wherein the piston is adapted to displace towards the first end based on receipt of the hydraulic fluid from the at least one hydraulic device.

14. The accumulator of claim 1, wherein the piston includes a cylindrical cup shaped structure.

15. The accumulator of claim 1, wherein the cavity is centrally disposed within the piston.

16. The accumulator of claim 1, wherein the cavity extends along more than half of the length of the piston.

17. A method of operating an accumulator, the method comprising:
communicating, fluidly, the accumulator with at least one hydraulic device, wherein the accumulator includes an accumulator housing defining a first end, a second end opposite to the first end, and a hollow chamber, and a piston that divides the hollow chamber into a gaseous chamber and a hydraulic chamber, and wherein the piston defines a first side surface in communication with the gaseous chamber, a second side surface in communication with the hydraulic chamber, and a cavity extending from the second side surface towards the first side surface along a length of the piston such that the cavity is in fluid communication with the hydraulic chamber;
receiving, from the at least one hydraulic device, a hydraulic fluid within the hydraulic chamber and the cavity; and
displacing the piston towards the first end by a maximum displacement based on receipt of the hydraulic fluid within the hydraulic chamber and the cavity, wherein a first pressure within the gaseous chamber is greater than a second pressure within the hydraulic chamber and the cavity when the piston is displaced towards the first end by the maximum displacement.

18. The method of claim 17 further comprising decreasing a first volume defined by the gaseous chamber based on a displacement of the piston towards the first end.

19. The method of claim 18 further comprising increasing a second volume defined by the hydraulic chamber and the cavity based on the displacement of the piston towards the first end, wherein the second volume is greater than the first volume when the piston is displaced towards the first end by the maximum displacement.

20. The method of claim 17, wherein the step of receiving the hydraulic fluid further includes providing fluid communication of the hydraulic chamber and the cavity with the at least one hydraulic device.
